(19) United States
(12) Patent Application Publication
(10) Pub. No.: US 2017/0280120 A1
(43) Pub. Date: Sep. 28, 2017

(54) PROJECTION SYSTEM AND METHOD FOR CORRECTING PROJECTION IMAGE

(71) Applicant: Coretronic Corporation, Hsin-Chu (TW)

(72) Inventors: Kuei-Chin Lai, Hsin-Chu (TW); Chih-Chen Chen, Hsin-Chu (TW)

(73) Assignee: Coretronic Corporation, Hsin-Chu (TW)

(21) Appl. No.: 15/461,475

(22) Filed: Mar. 17, 2017

(30) Foreign Application Priority Data
Mar. 28, 2016 (CN) 201610181828.0

(51) Int. Cl. H04N 9/31; G06T 7/73; G06K 9/00

(52) U.S. Cl. CPC H04N 9/3185; G06K 9/00201; H04N 9/3194; G06T 7/74; G06T 2207/10024

(57) ABSTRACT

A projection system and a method for correcting projection image are provided. The projection system includes a projection target, a projection apparatus and an image capturing device. The projection target includes a reference pattern, and receives an image beam to display a projection image in collaboration with the image beam. The projection apparatus projects the image beam to the projection target. The image capturing device captures a captured image having the projection image, and outputs the captured image to the projection apparatus. The projection apparatus adjusts a projection parameter of the image beam according to the projection image in the captured image. Based on the adjusted projection parameter, the corrected projection image displayed by the image beam corresponds to the reference pattern.

### CROSS-REFERENCE TO RELATED APPLICATION

This application claims the priority benefit of China application serial no. 201610181828.0, filed on Mar. 28, 2016. The entirety of the above-mentioned patent application is hereby incorporated by reference herein and made a part of this specification.

### BACKGROUND OF THE INVENTION

Field of the Invention

The invention relates to a projection system, and particularly relates to a projection system and a method for correcting projection image.

Description of Related Art

Presently, optical axis correction is a very important part in assembly of a projection system, especially for an embedded projection module, a relative position between a projector and a projection surface has to be adjusted during the assembly, such that a projection image of the projector can be presented at a correct position of the projection surface in an actual practice. However, the process of the optical axis correction is both time-consuming and labor-consuming, and a professional staff has to use an adjusting tool to adjust the projection systems one-by-one. Moreover, if the projection systems are required to be additionally assembled after being manufactured, the projection systems have to be fine-tuned after being manufactured. If the projectors are delivered to a customer in a manner of modules, when the customer assembles the projection systems, the projection systems have to be again fine-turned. Besides, after a long period of use or after reassembly of related machine due to maintenance, the projection system needs to be corrected, and each correction is implemented in the time-consuming and labor-consuming manner, such that maintenance of the projection system is inconvenient. Therefore, it is an important issue concerted by related technicians of the field to implement correction of the projection system in a simple manner, so that the projection image of the projector can be presented at a correct position on the projection surface.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

The invention is directed to a projection system, which is adapted to implement automatic correction of a projection image.

The invention provides a method for correcting a projection image, which is adapted to implement automatic correction of a projection image of a projection system.

Other objects and advantages of the invention can be further illustrated by the technical features broadly embodied and described as follows.

In order to achieve one or a portion of or all of the objects or other objects, an embodiment of the invention provides a projection system including a projection target, a projection apparatus and an image capturing device. The projection target includes a reference pattern, and is adapted to receive an image beam, so as to display a projection image in collaboration with the image beam. The projection apparatus is adapted to project the image beam to the projection target. An image capturing device captures the projection image and generates a captured image, and outputs the captured image to the projection apparatus. The projection apparatus adjusts a projection parameter of the image beam according to the projection image in the captured image. Based on the adjusted projection parameter, the corrected projection image displayed by the image beam corresponds to the reference pattern.

In order to achieve one or a portion of or all of the objects or other objects, an embodiment of the invention provides a method for correcting projection image. The method for correcting a projection image is adapted to a projection system, and the projection system includes a projection target, a projection apparatus and an image capturing device. The method for correcting projection image includes following steps. An image beam is projected to the projection target, such that the image beam displays the projection image in collaboration with the projection target, where the projection target includes a reference pattern. The projection image is captured to generate a captured image, and a projection parameter of the image beam is adjusted according to the projection image in the captured image, where based on the adjusted projection parameter, the corrected projection image displayed by the image beam corresponds to the reference pattern.

According to the above description, the embodiments of the invention have at least one of the following advantages or effects. In the embodiments of the invention, the projection target of the projection system further includes a three-dimensional feature, and is adapted to receive the image beam to display the projection image in collaboration with the image beam. The image capturing device of the projection system captures the projection image to generate the captured image, and outputs the captured image to the projection apparatus. The projection apparatus adjusts the projection parameter of the image beam according to the projection image in the captured image. Based on the adjusted projection parameter, the corrected projection image displayed by the image beam matches the three-dimensional feature. Moreover, the method for correcting the projection image of the invention is adapted to the aforementioned projection system, based on the method for correcting the projection image and the aforementioned projection system, the projection image of the projection system may fall on a correct position on the projection target, so as to implement the automatic correction of the projection image. Therefore, the projection system has good correction convenience.

In order to make the aforementioned and other features and advantages of the invention comprehensible, several exemplary embodiments accompanied with figures are described in detail below.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional view of a projection system according to an embodiment of the invention.

FIG. 2A illustrates a predetermined projection image in the projection system of the embodiment of FIG. 1.

FIG. 2B illustrates a projection target of the projection system of the embodiment of FIG. 1.

FIG. 2C illustrates a captured image including a projection image generated by an image capturing device of the embodiment of FIG. 1.

FIG. 2D illustrates a predetermined projection image corresponding to an image beam with adjusted projection parameter of the embodiment of FIG. 1.

FIG. 2E is a schematic diagram of a corrected projection image of the embodiment of FIG. 1 in collaboration with the 3D feature.

FIG. 3 is a flowchart illustrating a method for correcting projection image according to an embodiment of the invention.

FIG. 4 is a three-dimensional view of a projection system according to another embodiment of the invention.

FIG. 5 illustrates a predetermined projection image of the projection system of the embodiment of FIG. 4.

FIG. 6 illustrates a projection target of the projection system of the embodiment of FIG. 4.

FIG. 7 illustrates a captured image having the projection image that is captured by the image captured device of the embodiment of FIG. 4.

FIG. 8 illustrates a predetermined projection image corresponding to an image beam with adjusted projection parameter of the embodiment of FIG. 4.

FIG. 9 is a schematic diagram of a corrected projection image of the embodiment of FIG. 4.

FIG. 10 is a flowchart illustrating a method for correcting projection image according to another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of

“A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The invention will now be described more fully with reference to the accompanying drawings, in which exemplary embodiments of the invention are shown. The terms used herein such as “above”, “below”, “front”, “back”, “left” and “right” are for the purpose of describing directions in the figures only and are not intended to be limiting of the invention.

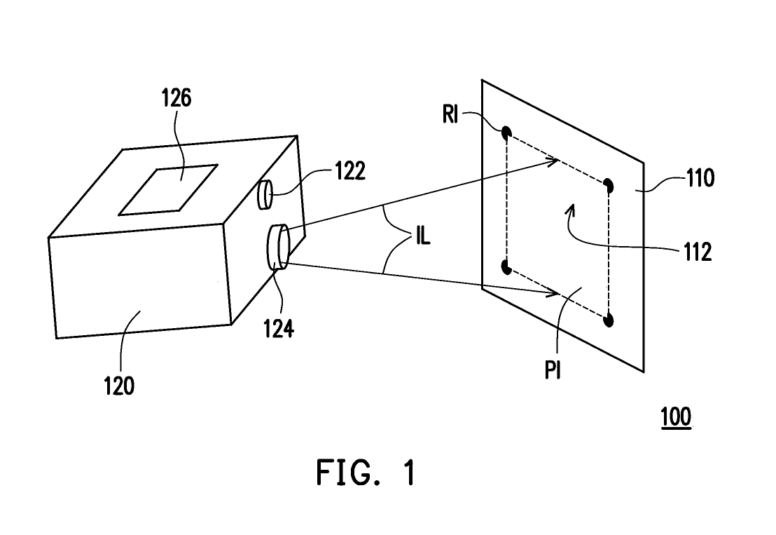

FIG. 1 is a three-dimensional view of a projection system according to an embodiment of the invention. In the present embodiment, the projection system 100 includes a projection target 110 and a projection apparatus 120. The projection apparatus 120 is adapted to project an image beam IL to the projection target 110, and the projection target 110 is adapted to receive the image beam IL to display a projection image PI in collaboration with the image beam IL. To be specific, the projection target 110 includes a three-dimensional (3D) feature 112 and a reference pattern RI, and the projection apparatus 120 is adapted to correspondingly project the image beam IL onto the 3D feature 112 of the projection target 110. The projection apparatus 120 is, for example, a projector, and the projection target 110 is selected from a 3D object or a planar or curved projection screen including the 3D feature 112.

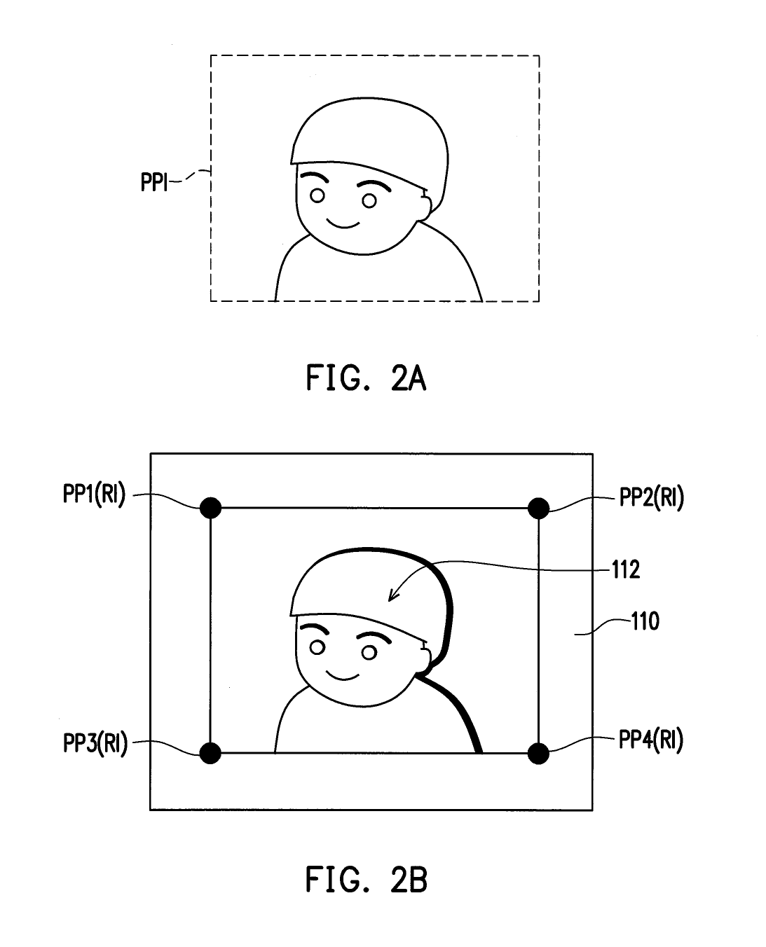

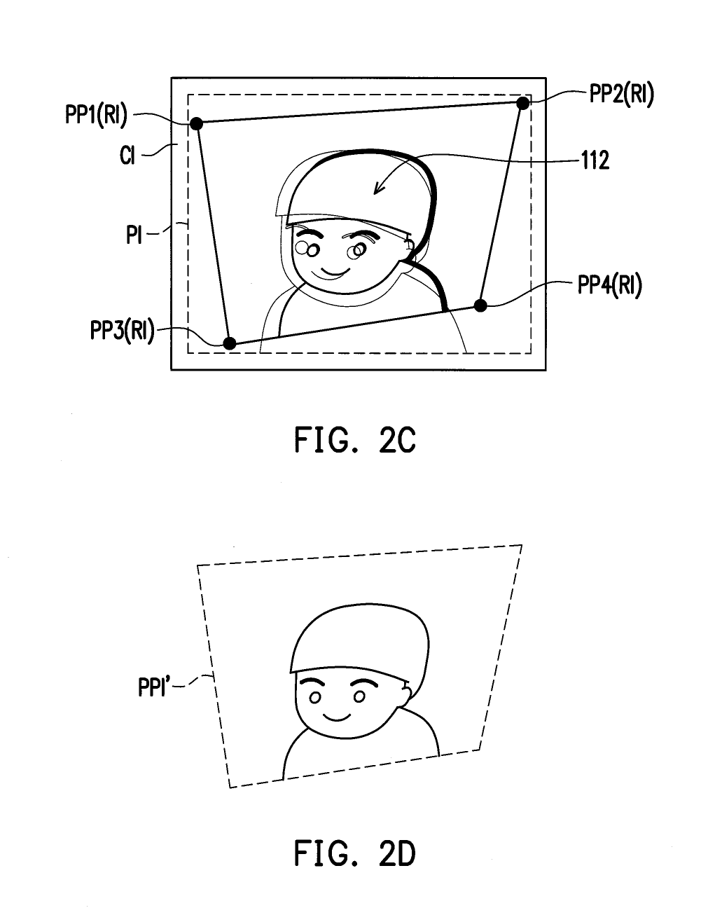

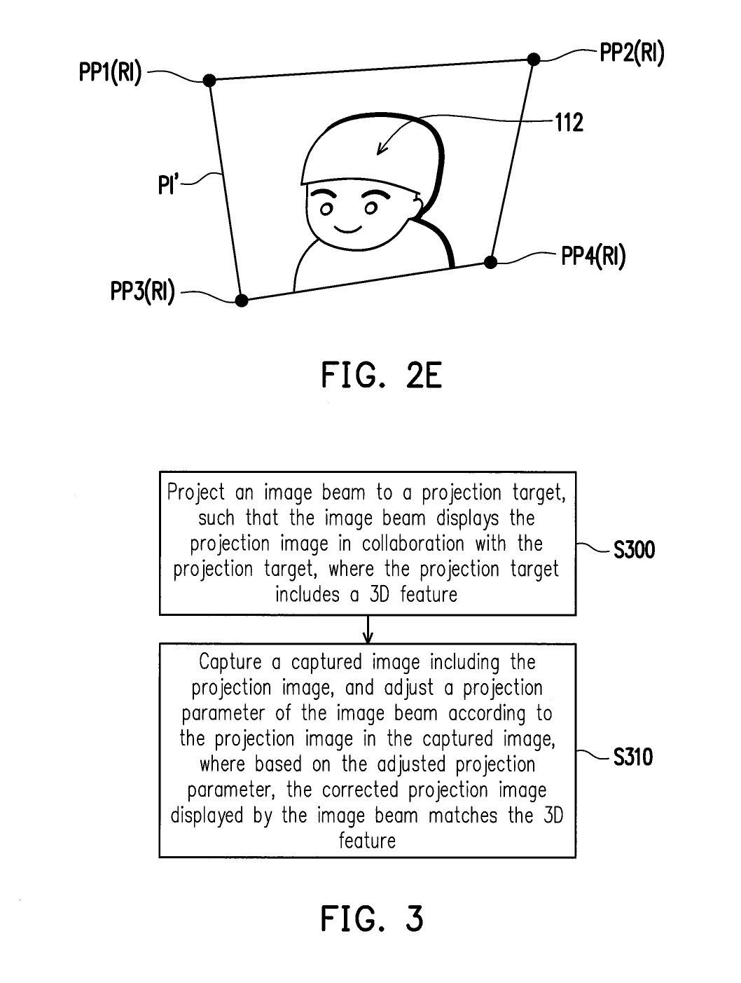

FIG. 2A illustrates a predetermined projection image in the projection system of the embodiment of FIG. 1, and FIG. 2B illustrates a projection target of the projection system of the embodiment of FIG. 1. Referring to FIG. 1, FIG. 2A and FIG. 2B, the projection apparatus 120 includes a projection device 124, which is adapted to project the image beam IL to the projection target 110, such that the predetermined projection image PPI is projected to the projection target 110. The projection device 124 is, for example, a projection lens, and the projection target 110 is, for example, a planar projection screen including the 3D feature 112 and the reference pattern RI, and the reference pattern RI is described in detail later. In the present embodiment, the predetermined projection image PPI (the projection image PI) is, for example, a character image, and the 3D feature 112 on the projection target 110 is, for example, a 3D relief of all of or a part of a profile of the character in the aforementioned character image of the corresponding predetermined projection image PPI (the projection image PI). For example, the 3D feature 112 can be the 3D relief of a part of the profile, for example, a profile of a human face without mouth, and by projecting the predetermined projection image PPI, an image variation effect can be implemented at the place of the mouth, for example, to form a crying face or a smiling face. In the present embodiment, when a user operates the projection apparatus 120 to project the image beam IL to the projection target 110 through the projection device 124, through proper adjustment, the character image in the projection image PI can be matched to the 3D relief of the profile of the character on the projection target 110. However, in other embodiments, the projection target 110 can be a 3D object, for example, a 3D sculpture, or a curved projection screen. Moreover, the projection image PI can be selected adopted to preset the 3D feature 112 on the projection target 110 according to an actual requirement, though the invention is not limited thereto.

FIG. 2C illustrates a captured image generated by an image capturing device of the embodiment of FIG. 1 by capturing the projection image. Referring to FIG. 1 and FIG. 2C, in the present embodiment, the projection apparatus 120 further includes an image capturing device 122 and a processing device 126, where the processing device 126 is electrically connected to the image capturing device 122 and the projection device 124. The image capturing device 122 is, for example, a camera lens, which is disposed on a surface of the projection apparatus 120 and located on a same side surface of the projection apparatus 120 with the projection device 124, and faces the projection target 110 to capture the projection image PI projected by the projection device 124. To be specific, the image capturing device 122 captures the captured image CI (for example, the captured image CI shown in FIG. 2C) having the projection. image PI, and outputs the captured image CI to the processing device 126 of the projection apparatus 120. Moreover, the projection apparatus 120 adjusts a projection parameter of the image beam IL according to the projection image PI in the captured image CI. In detail, the processing device 126 of the projection apparatus 120 receives the captured image CI from the image capturing device 122, and analyzes the projection image PI in the captured image CI according to an image analysis method, and adjusts the projection parameter of the image beam IL according to an analysis result. In the present embodiment, the processing device 126 is, for example, a central processing unit (CPU), a microprocessor, a digital signal processor (DSP), a programmable controller, a programmable logic device (PLD) or other similar device or a combination of the above devices, which is not limited by the invention. Since those skilled in the art can learn enough instructions and recommendations for the internal circuit structure of the processing device 126 and the implementation method thereof from general knowledge of the field, detailed description thereof is not repeated. Moreover, in some other embodiments, the image capturing device 122 can also be disposed in internal of the projection apparatus 120. Alternatively, the projection apparatus 120 does not include the image capturing device 122, and the image capturing device 122 is independently disposed outside the projection apparatus 120. For example, the image capturing device 122 is externally connected to the projection apparatus 120 in a wired or wireless manner, which is not limited by the invention.

Referring to FIG. 2B and FIG. 2C, and compared to FIG. 1, in the present embodiment, the projection target 110 includes the reference pattern RI, and the processing device 126 of the projection apparatus 120 adjusts the projection parameter of the image beam IL according to the reference pattern RI of the projection target 110. To be specific, the reference pattern RI is, for example, a positioning point PP1, a positioning point PP2, a positioning point PP3 and a positioning point PP4 that are not coincided with each other, and the positioning point PP1, the positioning point PP2, the positioning point PP3 and the positioning point PP4 of the reference pattern RI are different to the 3D feature 112 on the projection target 110. Moreover, the captured image CI having the projection image PI that is captured by the image capturing device 122 also includes the positioning point PP1, the positioning point PP2, the positioning point PP3 and the positioning point PP4 on the projection target 110. Connection lines between the positioning points are used for easy understanding of separation of related regions, and are not necessary lines.

Referring to FIG. 2A and FIG. 2C, in the present embodiment, since the projection apparatus 120 and the projection target 110 are liable to have a tolerance due to assembly factors, an optical axis of the projection device 124 of the projection apparatus 120 is inclined relative to the projection target 110, or the projection target 110 is a curved surface or a 3D object, etc., when the projection apparatus 120 projects the image beam IL to the projection target 110, and the projection target 110 displays the projection image PI in collaboration with the image beam IL, a shape or a size of the projection image PI displayed on the projection target 110 is probably different to a shape or a size of the predetermined projection image PPI, and the projection effect expected by the user cannot be achieved. For example, the optical axis of the image beam IL projected by the projection device 124 is probably not perpendicular to the surface of the projection target 110, such that the projection image PI presents a trapezoid or an irregular quadrilateral, and is not matched to a rectangle of the original predetermined projection image PPI. For another example, the projection target 110 probably has a rotation angle along the optical axis of the image beam IL, such that the four sides of the projection image PI and the corresponding edges of the projection target 110 respectively have an included angle therebetween, which is not complied with the projection effect expected by the user.

Referring to FIG. 1, FIG. 2A, FIG. 2B and FIG. 2C, the predetermined projection image PPI of the present embodiment is a rectangle and has a pattern corresponding to the 3D feature 112 of the projection target 110, and the rectangular predetermined projection image PPI has four corners. The reference pattern RI on the projection target 110 is, for example, a quadrilateral, and the positioning point PP1, the positioning point PP2, the positioning point PP3 and the positioning point PP4 of the reference pattern RI are four points of the quadrilateral. When the projection apparatus 120 has a tolerance due to the assembly factors, or due to a variation of a distance between the projection apparatus 120 and the projection target 110, as shown in FIG. 2C, when the projection image PI is projected to the projection target 110, the positioning point PP1, the positioning point PP2, the positioning point PP3 and the positioning point PP4 of the reference pattern RI in the captured image CI captured by the image capturing device 122 form four pints of the deformed quadrilateral, i.e. the quadrilateral constructed by the positioning point PP1, the positioning point PP2, the positioning point PP3 and the positioning point PP4 of the reference pattern RI in the captured image CI is different to the quadrilateral constructed by the positioning point PP1, the positioning point PP2, the positioning point PP3 and the positioning point PP4 of the reference pattern RI of the projection target 110. According to the captured image CI, it is learned that the four corners of the projection image PI projected by the projection device 124 of the projection apparatus 120 do not fall on the positioning point PP1, the positioning point PP2, the positioning point PP3 and the positioning point PP4 of the reference pattern RI of the projection target 110, i.e. at least one corner of the projection image PI is not coincided with the corresponding positioning point of the reference pattern RI. Meanwhile, the pattern (the character image) of the 3D feature 112 corresponding to the projection target 110 in the projection image PI of the captured image CI is not matched to the 3D relief (the 3D feature 112) of the profile of the character on the projection target 110. Therefore, the user may see a chaotic image. For example, since two eyes of the character in the projection image PI are not projected to positions of the two eyes of the character in the 3D feature 112 of the projection target 110, the user may view that the two eyes of the character in the projection image PI and the two eyes of the character in the 3D feature 112 are located at different positions on the projection target 110, so that the user may see a chaotic image.

FIG. 2D illustrates a predetermined projection image corresponding to the image beam with adjusted projection parameter of the embodiment of FIG. 1, and FIG. 2E is a schematic diagram of the corrected projection image of the embodiment of FIG. 1 in collaboration with the 3D feature. Referring to FIG. 1, FIG. 2C, FIG. 2D and FIG. 2E, in the present embodiment, the processing device 126 of the projection apparatus 120 adjusts the projection parameter of the image beam IL according to the projection image PI in the captured image CI, and based on the adjusted projection parameter, the corrected projection image PI′ displayed by the image beam IL matches the 3D feature 112 on the projection target 110. To be specific, the processing device 126 is configured with an image identifying engine to analyze the position of the image beam IL projected to the projection target 110 in the captured image CI and the position of the reference pattern RI on the projection target 110, so as to obtain the four corners of the projection image PI in the captured image CI and coordinate information of the positioning points of the reference pattern RI, for example, coordinate values of the positioning point PP1, the positioning point PP2, the positioning point PP3 and the positioning point PP4 in the captured image CI. Then, the processing device 126 adopts an image correcting engine to project the image beam IL onto the projection target 110, and the four corners of the projection image PI′ presented on the projection target 110 by the corrected image beam IL may respectively correspond to the coordinate information of the four positioning points of the reference pattern RI, and the pattern (the character image) of the 3D feature 112 corresponding to the projection target 110 in the projection image PI′ is adjusted to the position of the 3D relief (the 3D feature 112) of the profile of the character on the projection target 110.

The processing device 126 uses the image correcting engine to adjust the coordinate information of the image beam IL projected to the projection target 110 to form an adjusted predetermined projection image PPI′ (shown in FIG. 2D). When the adjusted predetermined projection image PPI′ is projected to the projection target 110 through the projection apparatus 120, in the captured image CI captured by the image capturing device 122, the four corners of the presented projection image PI′ are respectively coincided with the coordinate information of the four positioning points of the reference pattern RI, and are correspondingly matched to the position of the 3D feature 112 (shown in FIG. 2E). For example, the processing device 126 may use the image correcting engine to adjust the predetermined projection image PPI to form the adjusted predetermined projection image PPI′, where the shape adjustment of the predetermined projection image PPI′ is performed according to the coordinate information of the positioning point PP1, the positioning point PP2, the positioning point PP3 and the positioning point PP4 of the projection target 110 in the captured image CI. Therefore, when the corrected projection image PI′ is displayed on the projection target 110, the four corners of the corrected projection image PI′ correspondingly fall on the positioning point PP1, the positioning point PP2, the positioning point PP3 and the positioning point PP4 of the reference pattern RI on the projection target 110. Now, the character image in the corrected projection image PI′ is matched to the 3D relief (the 3D feature 112) of the profile of the character on the projection target 110. Therefore, the corrected projection image PI′ of the projection system 100 may fall on the corresponding correct position on the projection target 110, and the character image can be accurately coincided with the 3D feature 112 of the projection target 110. In this way, the user does not see the chaotic image. To be specific, the projection system 100 may implement automatic correction of the projection image thereof without performing the correction through a manual approach. Therefore, the projection system 100 has good correction convenience.

In the present embodiment, the image correcting engine is, for example, implemented through a hardware or software approach, since those skilled in the art can learn enough instructions and recommendations for the implementation method thereof from general knowledge of the field, detailed description thereof is not repeated. Moreover, in some embodiments, different number of the positioning points can be selectively adopted to correct the projection image, which is not limited by the invention. Moreover, in the present embodiment, the 3D feature 112 does not include the reference pattern RI (i.e. the positioning point PP1, the positioning point PP2, the positioning point PP3 and the positioning point PP4), and the reference pattern RI is different to the pattern of the 3D feature 112. However, in some embodiments, the 3D feature 112 may also include the reference pattern RI, and the reference pattern RI is a part of the 3D feature 112. For example, the facial features or other features of the character in the 3D feature 112 can be used as the positioning points for correcting the projection image, which is not limited by the invention.

Moreover, in the present embodiment, the projection parameter of the image beam IL includes a position where the image beam IL is projected to the projection target 110, for example, the coordinate information of the four corners of the projection image PI presented as the image beam IL is projected to the projection target 100. However, in other embodiments, the projection parameter of the image beam IL may also include a focusing position of the projection apparatus 120. To be specific, by analyzing a color, a shape or a feature spacing of the 3D feature 112 on the captured image CI, the focusing position of the projection apparatus 120 can be obtained. In another embodiment, by analyzing a color, a shape of any one of or a spacing between any two of the positioning point PP1, the positioning point PP2, the positioning point PP3 and the positioning point PP4 of the reference pattern RI on the captured image CI, the focusing position of the projection apparatus 120 can also be obtained. In these embodiments, by obtaining the focusing position of the projection apparatus 120, the projection apparatus 120 may project the image beam IL to display the corrected projection image, and the projection image is clear.

FIG. 3 is a flowchart illustrating a method for correcting projection image according to an embodiment of the invention. The method for correcting projection image is at least adapted to the projection system 100 of FIG. 1. The method for correcting projection image includes following steps. In step S300, an image beam is projected to a projection target, such that the image beam displays the projection image in collaboration with the projection target, where the projection target includes a reference pattern. Then, in step S310, a captured image including the projection image is captured, and a projection parameter of the image beam is adjusted according to the projection image in the captured image, where based on the adjusted projection parameter, the corrected projection image displayed by the image beam matches the 3D feature.

For example, taking the projection system 100 of FIG. 1 as an example, in the step S310, the image capturing device 122 may face the projection target 110 to capture images. Each time when the image capturing device 122 captures an image, the image capturing device 122 outputs a captured image CI to the processing device 126 of the projection apparatus 120. Moreover, the processing device 126 applies the image identifying engine to find a position, a specific color or a positioning point with a specific shape of the projection image PI in the captured image CI and the reference pattern RI of the projection target 110, so as to obtain the coordinate information of the specific positioning point of the projection image PI and the positioning points of the reference pattern RI in the captured image CI, for example, the image identifying engine is used to find the coordinate information of the four corners of the quadrilateral projection image PI in the captured image CI and the coordinate information of the four positioning points of the reference pattern RI. To be specific, the processing device 126 may obtain coordinate values of the four corners of the projection image PI in the captured image CI of FIG. 2C and the coordinate values of the positioning point PP1, the positioning point PP2, the positioning point PP3 and the positioning point PP4 in the captured image CI.

Then, the processing device 126 calculates a matrix formed by the coordinate values of the positioning point PP1, the positioning point PP2, the positioning point PP3 and the positioning point PP4 of the reference pattern RI in the captured image CI, and the processing device 126 calculates a transforming matrix according to the aforementioned matrix and a matrix formed by the four corners of the predetermined projection image PPI. The processing device 126 may adjust the position of the projection image formed by the image beam IL projected to the projection target 110 through the transforming matrix, so as to transform the predetermined projection image PPI into the adjusted predetermined projection image PPI′. The adjusted predetermined projection image PPI′ may correspond to the positioning points of the reference pattern RI and the position of the 3D feature 112 on the projection target 110, such that the corrected projection image PI′ displayed by the image beam IL matches the positioning points of the reference pattern RI and the 3D feature 112 on the projection target 110.

After the image beam IL is adjusted, the image capturing device 122 may further capture an image, and outputs another captured image CI to the processing device 126. Moreover, the processing device 126 may again adjust the position of the image beam IL projected to the projection target 110 according the captured image CI by using the aforementioned method. By continuously repeating the aforementioned step, the position of the projection image on the projection target 110 can be continuously corrected until a corresponding error value of the projection image falls within an allowable error range. To be specific, the error value is, for example, an offset value between a corner of the projection image corresponding to a positioning point of the reference pattern RI and the positioning point in the captured image CI. Moreover, the definition of the error value corresponding to the projection image can be specified according to an actual projection requirement, and the allowable error range can also be specified according to the same, though the invention is not limited thereto.

Moreover, in the embodiment, a speed of the aforementioned automatic correction can be determined according to an image capturing speed of the image capturing device 122 and a processing speed of the processing device 126. For example, when the image capturing device 122 captures the captured images in a speed of n images per second, and when the processing unit 126 corrects the position of the projection image of the captured image on the projection target 110 in a speed of n images per second, the projection system 100 may implement the automatic correction in a speed of n times per second.

In the embodiment, the method for correcting projection image can also be applied to automatic focusing of the projection system 100. For example, taking the projection system 100 of FIG. 1 as an example, in the step 5310, the image capturing device 122 may capture images and output the captured image CI to the processing device 126. Moreover, the processing device 126 may use the image identifying engine to find a position, a specific color and a positioning point with a specific shape in the reference pattern RI of the captured image CI, so as to obtain a plane constructed by the positioning points of the reference pattern RI. To be specific, the processing device 126 may obtain the plane constructed by the positioning point PP1, the positioning point PP2, the positioning point. PP3 and the positioning point PP4 shown in FIG. 2C. In detail, the image capturing device 122 continuously captures the captured images in the speed of n images per second, and transmits the captured images to the processing device 126, and the processing device 126 uses the image identifying engine to find a position, a specific color and a positioning point with a specific shape in the reference pattern RI of the captured image in the speed of n images per second, so as to obtain the plane constructed by the positioning points, where n is a positive integer, and is a not a fixed value.

Then, the processing device 126 processes the predetermined projection image PPI according to the plane, and maps the plane to a plane perpendicular to a projection direction. Moreover, the processing device 126 deduces a variation of a projection distance according to a variation of the spacing between the positioning points of the plane. By deducing the variation of the projection distance, the projection apparatus 120 may project the image beam IL to display the corrected projection image through the focusing function of the projection device 124, such that the projection image displayed on the projection target 110 is clear. In the embodiment, a speed of the aforementioned automatic focusing can also be determined according to the image capturing speed of the image capturing device 122 and the processing speed of the processing device 126.

Moreover, since those skilled in the art can learn enough instructions and recommendations for the method for correcting projection image of the embodiment of the invention from the description of the embodiments of FIG. 1 to FIG. 2E, detailed description thereof is not repeated.

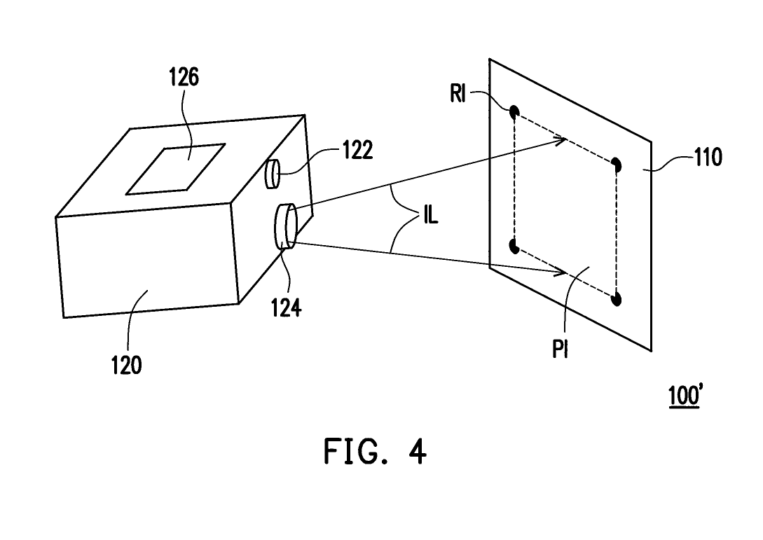

Moreover, FIG. 4 is a three-dimensional view of a projection system according to another embodiment of the invention. In the embodiment, configuration of the projection system 100′ is similar to that of the projection system of FIG. 1, which is not repeated, and the referential number of FIG. 1 is adopted, and a difference therebetween is that the projection target 110 can be a wall, a planar or a curved projection screen, and the projection target 110 includes the reference pattern RI. The reference pattern RI can be a plurality of predetermined positioning points, or four corners of the projection target 110, though the invention is not limited thereto.

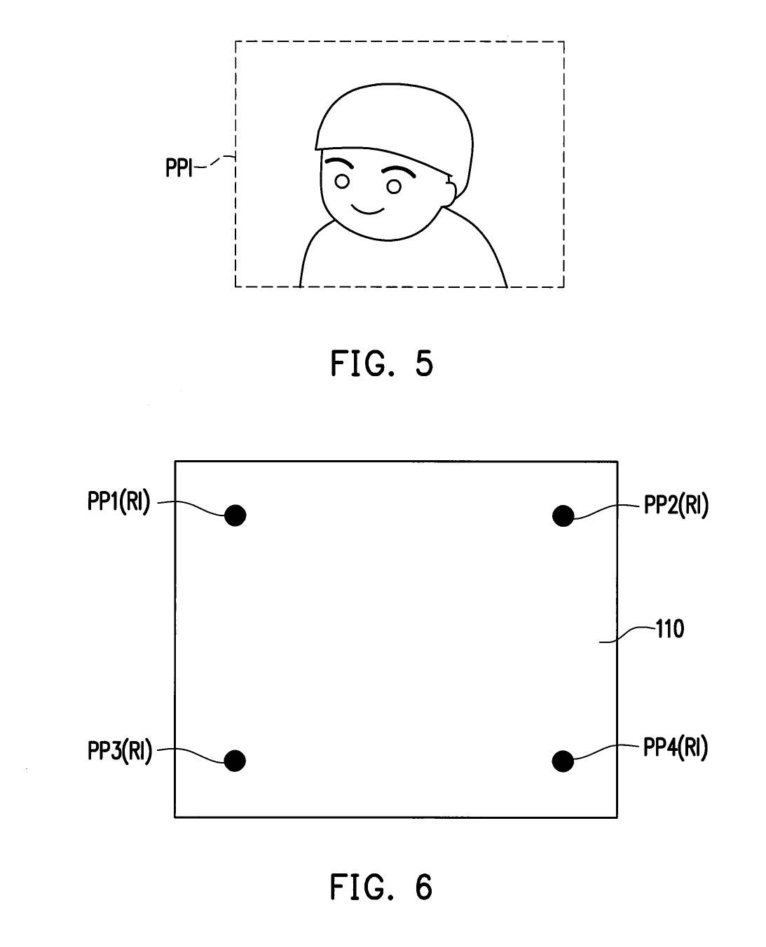

FIG. 5 illustrates a predetermined projection image of the projection system of the embodiment of FIG. 4. FIG. 6 illustrates a projection target of the projection system of the embodiment of FIG. 4. Referring to FIG. 4, FIG. 5 and FIG. 6, the projection apparatus 120 includes the projection device 124, which is adapted to project the image beam IL to the projection target 110, such that the predetermined projection image PPI is projected to the projection target 110. The projection target 110 is, for example, a planar projection screen including the reference pattern RI, where the reference pattern RI is, for example, the positioning point PP1, the positioning point PP2, the positioning point PP3 and the positioning point PP4 that are not coincided with each other. In another embodiment, the positioning points can be set at four corners of the projection target 110. In the embodiment, as shown in FIG. 5, the predetermined projection image PPI (the projection image PI) is, for example, a character image.

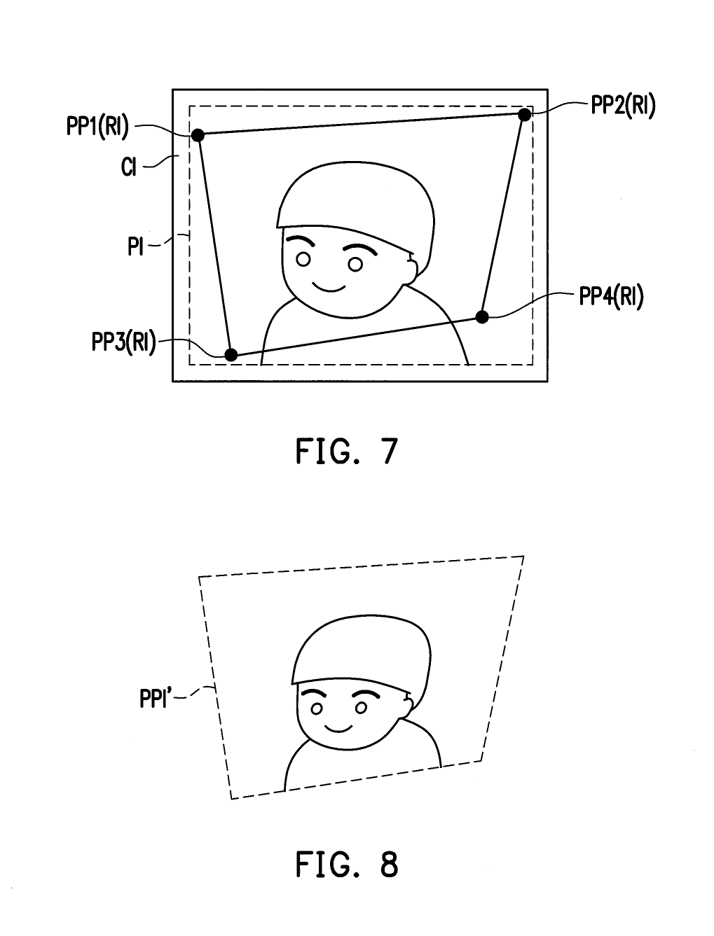

FIG. 7 illustrates a captured image generated by the image capturing device of the embodiment of FIG. 4 by capturing the projection image. Referring to FIG. 4 and FIG. 7, in the embodiment, the projection apparatus 120 includes the image capturing device 122 and the processing device 126. The image capturing device 122 is, for example, a camera lens, and faces the projection target 110 to capture the projection image PI projected by the projection device 124. To be specific, the image capturing device 122 captures the captured image CI including the projection image PI (for example, the captured image CI shown in FIG. 7), and outputs the captured image CI to the processing device 126 of the projection apparatus 120. Moreover, the projection apparatus 120 adjusts the projection parameter of the image beam IL according to the projection image PI in the captured image CI. In detail, the processing device 126 of the projection apparatus 120 receives the captured image CI from the image capturing device 122 and analyzes the projection image PI in the captured image CI according to an image analysis method, and adjusts the projection parameter of the image beam IL according to an analysis result.

Referring to FIG. 5 and FIG. 7, in the embodiment, the predetermined projection image PPI is a rectangular character image, and the rectangular predetermined projection image PPI has four corners. The reference pattern RI on the projection target 110 is, for example, a quadrilateral, and the positioning point PP1, the positioning point PP2, the positioning point PP3 and the positioning point PP4 of the reference pattern RI construct four points of the quadrilateral. When the projection apparatus 120 has a tolerance due to the assembly factors, or due to a variation of a distance between the projection apparatus 120 and the projection target 110, as shown in FIG. 7, in the captured image CI, the four corners of the projection image PI projected by the projection device 124 of the projection apparatus 120 do not fall on the positioning point PP1, the positioning point PP2, the positioning point PP3 and the positioning point PP4 of the reference pattern RI on the projection target 110, i.e. at least one corner of the projection image PI is not coincided with the corresponding positioning point of the reference pattern RI.

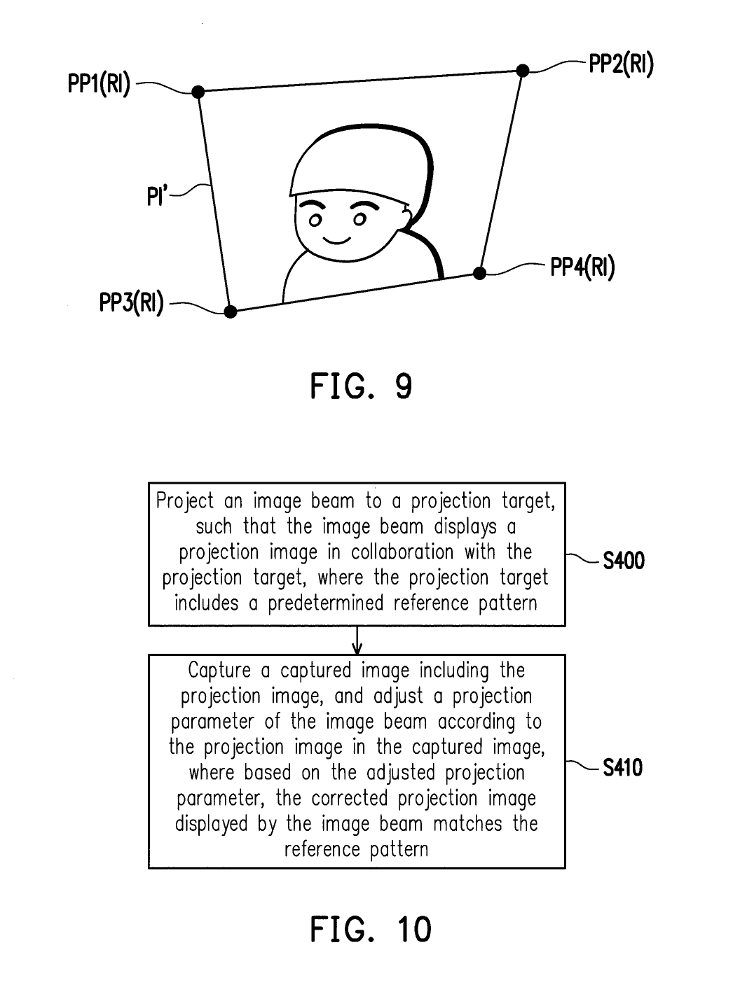

FIG. 8 illustrates a predetermined projection image corresponding to the image beam with the adjusted projection parameter of the embodiment of FIG. 4, and FIG. 9 is a schematic diagram of the corrected projection image of the embodiment of FIG. 4. In the embodiment, the processing device 126 uses the image correcting engine to adjust the coordinate information of the image beam IL projected to the projection target 110, so as to the adjusted predetermined projection image PPI′ (shown in FIG. 8). When the adjusted predetermined projection image PPI′ is projected to the projection target 110 through the projection apparatus 120, in the captured image CI captured by the image capturing device 122, the four corners of the projection image PI′ are respectively coincided with the coordinate information of the four positioning points of the reference pattern RI, as shown in FIG. 9.

To be specific, the processing device 126 of the projection apparatus 120 adjusts the projection parameter of the image beam IL according to the projection image PI in the captured image CI, and based on the adjusted projection parameter, the image beam IL displays the corrected projection image PI′. To be specific, the processing device 126 is configured to the image identifying engine to analyze the position of the image beam IL projected to the projection target 110 in the captured image CI and the position of the reference pattern RI on the projection target 110, so as to obtain the four corners of the projection image PI in the captured image CI and the coordinate information of the positioning points of the reference pattern RI, for example, coordinate values of the positioning point PP1, the positioning point PP2, the positioning point PP3 and the positioning point PP4 in the captured image CI. Then, the processing device 126 adopts an image correcting engine to project the image beam IL onto the projection target 110, and the four corners of the projection image PI′ presented on the projection target 110 by the corrected image beam IL may respectively correspond to the coordinate information of the four positioning points of the reference pattern RI, such that the corners of the projection image PI′ correspond to the four positioning points of the projection target 110. In this way, the projection system 100′ may implement automatic correction of the projection image thereof without performing the correction through a manual approach. Therefore, the projection system 100′ has good correction convenience.

FIG. 10 is a flowchart illustrating a method for correcting projection image according to another embodiment of the invention. The method for correcting projection image is at least adapted to the projection system 100′ of FIG. 4. The method for correcting projection image includes following steps. In step S400, an image beam is projected to a projection target, such that the image beam displays a projection image in collaboration with the projection target, where the projection target includes a predetermined reference pattern, for example, a plurality of positioning points. Then, in step S410, a captured image including the projection image is captured, and a projection parameter of the image beam is adjusted according to the projection image in the captured image, where based on the adjusted projection parameter, the corrected projection image displayed by the image beam matches the reference pattern.

For example, taking the projection system 100′ of FIG. 4 as an example, in the step S410, each time when the image capturing device 122 captures an image, the image capturing device 122 outputs a captured image CI to the processing device 126 of the projection apparatus 120. Moreover, the processing device 126 applies the image identifying engine to find a position, a specific color or a positioning point with a specific shape of the projection image PI in the captured image CI and the reference pattern RI of the projection target 110, so as to obtain the coordinate information of the specific positioning point of the projection image PI and the positioning points of the reference pattern RI in the captured image CI, for example, the image identifying engine is used to find the coordinate information of the four corners of the quadrilateral projection image PI in the captured image CI and the coordinate information of the four positioning points of the reference pattern RI. To be specific, the processing device 126 may obtain coordinate values of the four corners of the projection image PI in the captured image CI of FIG. 2C and the coordinate values of the positioning point PP1, the positioning point PP2, the positioning point PP3 and the positioning point PP4 in the captured image CI.

Then, the processing device 126 calculates a matrix formed by the coordinate values of the positioning point PP1, the positioning point PP2, the positioning point PP3 and the positioning point PP4 of the reference pattern RI in the captured image CI, and the processing device 126 calculates a transforming matrix according to the aforementioned matrix and a matrix formed by the four corners of the predetermined projection image PPI. The processing device 126 may adjust the position of the projection image formed by the image beam IL projected to the projection target 110 through the transforming matrix, so as to transform the predetermined projection image PPI into the adjusted predetermined projection image PPI′. The adjusted predetermined projection image PPI′ may correspond to the positions of the positioning points of the reference pattern RI on the projection target 110, such that the corrected projection image PI′ displayed by the image beam IL matches the positioning points of the reference pattern RI on the projection target 110.

After the image beam IL is adjusted, the image capturing device 122 may further capture an image, and outputs another captured image CI to the processing device 126. Moreover, the processing device 126 may again adjust the position of the image beam IL projected to the projection target 110 according the captured image CI by using the aforementioned method. By continuously repeating the aforementioned step, the position of the projection image on the projection target 110 can be continuously corrected until a corresponding error value of the projection image falls within an allowable error range. To be specific, the error value is, for example, an offset value between a corner of the projection image corresponding to a positioning point of the reference pattern RI and the positioning point in the captured image CI.

Moreover, in the embodiment, a speed of the aforementioned automatic correction can be determined according to an image capturing speed of the image capturing device 122 and a processing speed of the processing device 126. For example, when the image capturing device 122 captures the captured images in a speed of n images per second, and when the processing unit 126 corrects the position of the projection image of the captured image on the projection target 110 in a speed of n images per second, the projection system 100 may implement the automatic correction in a speed of n times per second.

In the embodiment, the method for correcting projection image can also be applied to automatic focusing of the projection system 100. For example, taking the projection system 100′ of FIG. 4 as an example, in the step S410, the image capturing device 122 may capture images and output the captured image CI to the processing device 126. Moreover, the processing device 126 may use the image identifying engine to find a position, a specific color and a positioning point with a specific shape in the reference pattern RI of the captured image CI, so as to obtain a plane constructed by the positioning points of the reference pattern RI. The processing device 126 may obtain the plane constructed by the positioning point PP1, the positioning point PP2, the positioning point PP3 and the positioning point PP4 shown in FIG. 7. In detail, the image capturing device 122 continuously captures the captured images in the speed of n images per second, and transmits the captured images to the processing device 126, and the processing device 126 uses the image identifying engine to find a position, a specific color and a positioning point with a specific shape in the reference pattern RI of the captured image in the speed of n images per second, so as to obtain the plane constructed by the positioning points, where n is a positive integer, and is a not a fixed value.

Then, the processing device 126 processes the predetermined projection image PPI according to the plane, and maps the plane to a plane perpendicular to the projection direction. Moreover, the processing device 126 deduces a variation of a projection distance according to a variation of the spacing between the positioning points of the plane. By deducing the variation of the projection distance, the projection apparatus 120 may project the image beam IL to display the corrected projection image through the focusing function of the projection device 124, such that the projection image displayed on the projection target 110 is clear. In the embodiment, a speed of the aforementioned automatic focusing can also be determined according to the image capturing speed of the image capturing device 122 and the processing speed of the processing device 126.

In summary, the embodiments of the invention have at least one of the following advantages or effects. In the embodiments of the invention, the projection target of the projection system includes a 3D feature, and is adapted to receive the image beam to display the projection image in collaboration with the image beam. The image capturing device of the projection system captures the captured image including the projection image, and outputs the captured image to the projection apparatus. The projection apparatus adjusts the projection parameter of the image beam according to the projection image in the captured image. Based on the adjusted projection parameter, the corrected projection image displayed by the image beam matches the reference pattern, or the corrected projection image displayed by the image beam matches the 3D feature. Moreover, the method for correcting the projection image of the invention is adapted to the aforementioned projection system, based on the method for correcting the projection image and the aforementioned projection system, the projection image of the projection system may fall on a correct position on the projection target, so as to implement the automatic correction of the projection image. Therefore, the projection system has good correction convenience.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents. Moreover, any embodiment of or the claims of the invention is unnecessary to implement all advantages or features disclosed by the invention. Moreover, the abstract and the name of the invention are only used to assist patent searching. Moreover, “first”, “second”, etc. mentioned in the specification and the claims are merely used to name the elements and should not be regarded as limiting the upper or lower bound of the number of the components/devices.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a projection target adapted to receive an image beam so as to display a projection image in collaboration with the image beam, wherein the projection target comprises a reference pattern;
a projection apparatus adapted to project the image beam to the projection target; and
an image capturing device is adapted to capture a captured image having the projection image and output the captured image to the projection apparatus, wherein the projection apparatus is adapted to adjust a projection parameter of the image beam according to the projection image in the captured image, and the corrected projection image displayed by the image beam corresponds to the reference pattern based on the adjusted projection parameter.

2. The projection system as claimed in claim 1, wherein the projection apparatus comprises the image capturing device, and the image capturing device is configured in internal or on a surface of the projection apparatus.

3. The projection system as claimed in claim 1, wherein the image capturing device is independently configured outside the projection apparatus.

4. The projection system as claimed in claim 1, wherein the projection apparatus is adapted to adjust the projection parameter of the image beam according to the reference pattern of the projection target.

5. The projection system as claimed in claim 4, wherein the projection target further comprises a three-dimensional feature, and the reference pattern is without the three-dimensional feature.

6. The projection system as claimed in claim 5, wherein the reference pattern is different to a pattern of the three-dimensional feature.

7. The projection system as claimed in claim 1, wherein the projection apparatus comprises:
a projection device adapted to project the image beam to the projection target; and
a processing device, electrically connected to the projection device, and adapted to analyze the projection image in the captured image according to an image analysis method, and adjust the projection parameter of the image beam according to an analysis result.

8. The projection system as claimed in claim 7, wherein the processing device is adapted to analyze a position of the image beam projected to the projection target and the reference pattern of the projection target by an image identifying engine, so as to obtain the position of the projection image in the captured image and coordinate information of the reference pattern.

9. The projection system as claimed in claim 8, wherein the processing device is adapted to project the image beam to the projection target by an image correcting engine, and the projection image is adapted to adjust to correspond to the coordinate information of the reference pattern, such that the corrected projection image displayed by the image beam corresponds to the reference pattern of the projection target.

10. The projection system as claimed in claim 8, wherein the processing device is adapted to project the image beam to the projection target by an image correcting engine, such that the projection image is adapted to adjust to correspond to the coordinate information of the reference pattern and a position of a three-dimensional feature of the projection target, and the corrected projection image is adapted to display by the image beam corresponds to the reference pattern and the three-dimensional feature.

11. The projection system as claimed in claim 1, wherein the projection parameter comprises at least one of a position of the image beam projected to the projection target and a focusing position of the projection apparatus.

12. The projection system as claimed in claim 9, wherein the focusing position of the projection apparatus is obtained by analyzing a color, a shape, a spacing between positioning points of the reference pattern on the captured image.

13. The projection system as claimed in claim 10, wherein the focusing position of the projection apparatus is obtained by analyzing a color, a shape, a feature spacing of the three-dimensional feature on the captured image.

14. A method for correcting projection image, adapted to a projection system, wherein the projection system comprises a projection target, a projection apparatus and an image capturing device, the method for correcting projection image comprising:
projecting an image beam to the projection target, such that the image beam displays the projection image in collaboration with the projection target, wherein the projection target comprises a reference pattern; and
capturing the projection image to generate a captured image, and adjusting a projection parameter of the image beam according to the projection image in the captured image, wherein based on the adjusted projection parameter, the corrected projection image displayed by the image beam corresponds to the reference pattern.

15. The method for correcting projection image as claimed in claim 14, wherein in the step of adjusting the projection parameter of the image beam according to the projection image in the captured image, the projection parameter of the image beam is adjusted according to the reference pattern of the projection target.

16. The method for correcting projection image as claimed in claim 14, wherein the projection target further comprises a three-dimensional feature, and the reference pattern does not comprise the three-dimensional feature.

17. The method for correcting projection image as claimed in claim 16, wherein the reference pattern is different to a pattern of the three-dimensional feature.

18. The method for correcting projection image as claimed in claim 14, wherein the step of adjusting the projection parameter of the image beam according to the projection image in the captured image comprises:
using an image identifying engine to analyze a position of the image beam projected to the projection target and the reference pattern of the projection target, so as to obtain the position of the projection image in the captured image and coordinate information of the reference pattern.

19. The method for correcting projection image as claimed in claim 18, wherein the step of adjusting the projection parameter of the image beam according to the projection image in the captured image comprises:
using an image correcting engine to project the image beam to the projection target, and adjusting the projection image to correspond to the coordinate information of the reference pattern, such that the corrected projection image displayed by the image beam corresponds to the reference pattern.

20. The method for correcting projection image as claimed in claim 14, wherein the projection parameter comprises at least one of a position of the image beam projected to the projection target and a focusing position of the projection apparatus.

21. The method for correcting projection image as claimed in claim 20, wherein the focusing position of the projection apparatus is obtained by analyzing a color, a shape, a spacing between positioning points of the reference pattern on the captured image.
